(19) United States
(12) Patent Application Publication
(10) Pub. No.: US 2017/0196245 A1
(43) Pub. Date: Jul. 13, 2017

(54) APPARATUS AND METHOD FOR HEATING A FOOD PRODUCT CONSTITUTED OF A SANDWICH OR THE LIKE, BEFORE IT IS CONSUMED

(71) Applicant: ILLINOIS TOOL WORKS INC., Glenview, IL (US)

(72) Inventors: Marco Bullo, Scorze (IT); Fabrizio Dughiero, Padova (IT); Francesco Gambato, San Giorgio in Bosco (IT); Michele Sclocchi, San Donato Milanese (IT)

(21) Appl. No.: 15/359,702

(22) Filed: Nov. 23, 2016

Related U.S. Application Data
(60) Provisional application No. 62/275,982, filed on Jan. 7, 2016.

(51) Int. Cl. A23L 5/10; A47J 37/06

(52) U.S. Cl. CPC A23L 5/15; A47J 37/06; A23V 2002/00

(57) ABSTRACT

A method and an apparatus for heating a food product constituted of a sandwich or the like, before it is consumed, in which the food product 4 is enclosed between at least a first heating element 6 and a second heating element 7 facing each other, the first heating element 6 comprising a first plurality 8 of electrically conductive raised elements 9 protruding towards the second heating element 7, and the second heating element 7 comprising a second plurality 10 of electrically conductive raised elements 9 protruding towards the first heating element 6, and is radio frequency heated using the raised elements 9 as electrodes 11, 12.

### CROSS-REFERENCE TO RELATED APPLICATIONS

This application claims priority to U.S. application No. 62/275,982 filed Jan. 7, 2016, the entire contents of which are hereby incorporated by reference.

### TECHNICAL FIELD

This disclosure relates in general to the sector of food preparation. Specifically, this disclosure relates to an apparatus and a method for heating a food product constituted of a sandwich (panino) or the like, before it is consumed. The expression sandwich or the like refers to any product that, similarly to a traditional sandwich, comprises an outer part made of bread and a filling. Therefore, the definition also covers products such as unleavened flat bread (piadina), deep-fried pizza roll (panzerotto), etc. However, hereinafter, for simplicity, reference will only be made to sandwiches, it being understood that this shall also cover any other similar product.

Even more precisely, this disclosure relates to the fast food sector, where it is common for sandwiches to be prepared in advance and preserved, generally in a refrigerator, until the moment when they are purchased by the consumer. Only then, before being handed over to the customer, is the sandwich heated.

### BACKGROUND

At least according to the intentions of the seller, the heating to which the sandwich is subjected before being handed over to the customer for consumption, should generally allow:

uniform heating of the entire sandwich;

if necessary, softening of cheese or other foods in the filling;

browning of the outer part and/or making it crisp or crisper.

At the same time, especially at points of sale with a large number of customers, it should be possible to do it all in the shortest possible time.

Over the years, while attempting to meet that requirement, various methods and apparatuses have been developed and/or used.

A first type of prior art apparatus, for example, comprises two plates heated by resistors, designed to compress the sandwich between them and to heat it mainly by conduction from the outside inwards.

Alternatively, small ovens were also used, both with resistors and with infrared, their operation being very similar to that of a common toaster.

In more recent years, market success has been enjoyed by apparatuses equipped with a heating system that combines microwaves, infrared and a plate using resistors.

However, all of these prior art technologies have several disadvantages.

Regarding heating systems using only resistors, only infrared or with resistors and infrared at the same time, there are two main types of disadvantages:
first, relatively long heating times (of around several minutes at least to achieve reasonable results);
second, significant lack of uniformity in the heating, so that if the inside of the sandwich is well heated, generally the outer crust is excessively toasted, whilst if the crust is toasted to the optimum degree, the center of the sandwich is still cold.

The problem of heating times has definitely been solved by the combined system, which simultaneously uses microwaves, infrared and resistors, allowing sandwiches to be heated even in just thirty seconds.

Although this type of apparatus also has some advantages as regards uniformity, the results achievable are, however, less than satisfactory. In fact, although the use of microwaves allows heat to be transferred directly in the sandwich, if the filling includes two or more types of products, the distribution of the heat between the various products really lacks uniformity. Generally, fatty products such as cheese are overheated, with an increase in temperature that is practically negligible for vegetable products (tomato, salad, etc.). That lack of uniformity is also accentuated by the limited heating times which do not even allow the heat to be distributed by normal diffusion.

In this context, it would therefore be desirable to have available an apparatus and a method for heating a food product constituted of a sandwich or the like, before it is consumed, which overcome the above-mentioned disadvantages.

In particular, it would be desirable to have available an apparatus and a method for heating a food product constituted of a sandwich or the like, before it is consumed, that allow both reduced heating times and a good temperature uniformity inside the food product.

Furthermore, it would be desirable to have available an apparatus and a method for heating a food product constituted of a sandwich or the like, before it is consumed, that with heating times comparable to those of the prior art combined system which simultaneously uses microwaves, infrared and resistors, allow more uniform heat distributions between the various products present in the sandwich.

### BRIEF SUMMARY OF SOME EXAMPLE EMBODIMENTS OF THE SUBJECT OF THE PRESENT DISCLOSURE

Specifically, this disclosure relates to an apparatus and a method for heating a food product constituted of a sandwich or the like, before it is consumed, which are at least mainly based on a radio frequency heating performed using electrodes comprising a set of conductive raised elements, as described in the appended claims.

As regards the method according to this disclosure, in general it comprises radio frequency heating of the food product using an electromagnetic field having a frequency of between 1 MHz and 300 MHz, preferably between 10 MHz and 50 MHz. In particular, preferably, the method comprises heating after having enclosed the food product between at least a first heating element, extending in a first plane of extension, and a second heating element facing the first heating element and extending in a second plane of extension that is parallel to the first plane of extension. The first heating element and the second heating element comprise the electrodes to be used for radio frequency heating. In particular, on one hand the first heating element comprises a first plurality of electrically conductive raised elements protruding relative to the first plane of extension towards the second heating element and the second heating element comprises a second plurality of electrically conductive raised elements protruding relative to the second plane of extension towards the first heating element, and on the other, the raised elements of the first plurality and of the second plurality are used as electrodes. Thanks to this system, it is possible to obtain, first, good heating uniformity throughout the whole of the inside of the food product. Preferably, in some embodiments raised elements 9 are each constituted by a bar that extends parallel to respective ones of the first and second planes of extension, while in other embodiments raised elements 9 are integrally provided as one or more plate-shaped conductive elements extending substantially parallel to respective ones of the first and second planes of extension.

According to several example embodiments, at least during the radio frequency heating step, the first heating element and the second heating element remain in contact with an outer surface of the food product. This embodiment is particularly advantageous for guaranteeing good browning and crispness of the outer surface of the food product. However, preferably, when the first heating element and the second heating element are in contact with the outer surface of the food product, the raised elements of the first plurality and of the second plurality also remain in contact with the surface of the food product. In this way, in addition, it may also be possible to obtain on the outer surface of the food product (on the bread) visible marking (lines) similar to that obtainable with traditional plates using resistors.

Some other example embodiments, during the radio frequency heating step, also comprise squeezing the food product between the first heating element and the second heating element, to accentuate the browning and marking effects described above, which are mainly linked to the local value of the divergence of the electric field applied (a value that is maximum at the surface of the electrodes).

Moreover, to further accentuate said effects, raised elements of the first plurality and/or of the second plurality are preferably used which have a cross-section (advantageously circular or elliptical), relative to their own main line of extension, having a maximum size that is less than or equal to 6 mm.

In some example embodiments, during the radio frequency heating step the electromagnetic field in the space between the first heating element and the second heating element is generated with a mean direction of propagation transverse to the first plane of extension.

In other example embodiments, during the radio frequency heating step the electromagnetic field in the space between the first heating element and the second heating element is generated with a mean direction of propagation parallel to the first plane of extension.

In yet other example embodiments, during the radio frequency heating step the electromagnetic field in the space between the first heating element and the second heating element is instead generated with a mean direction of propagation having a first component parallel to the first plane of extension and a second component transverse to the first plane of extension. In this case, it may also advantageously be the case that, in the absence of the food product, the first component and the second component of the electromagnetic field respectively have a first intensity and a second intensity which have a mutual ratio of between 0.5 and 2.

Depending on requirements, to prevent the electrodes in contact with the food product from being able to cool it, partly nullifying the effects of the heating, there may also be, during the radio frequency heating step or immediately before the radio frequency heating step, a step of heating at least the first plurality of raised elements and the second plurality of raised elements to a temperature that is in general less than but not too much less than the temperature to which the outer surface of the sandwich must be heated. It is usually a temperature between 90° C. and 140° C., preferably between 100° C. and 130° C. The step of heating the raised elements may even be performed only in the absence of a radio frequency signal applied to the electrodes. In that case, activation of the radio frequency heating and heating of the raised elements may alternate.

In preferred embodiments, the step of heating the raised elements may be carried out using induction heating, heating with resistors and/or using a hot fluid that is made to circulate in the self-same raised elements (which in that case will be tubular).

In some applications, during the radio frequency heating step there may also be an additional step of heating the surface of the food product using heating with infrared, resistors or hot air. When the additional heating step is used, it is not generally necessary for there to be contact between the first heating element and the second heating element, and in particular between the respective raised elements, and the food product.

Finally, to improve the distribution of heat in the most superficial layer of the food product, before the food product is inserted between the first heating element and the second heating element, there may be a step of applying an edible fat (oil or butter of any type) on the outer surface of the food product (if it does not already normally have some on it).

Moving on to the apparatus that forms the subject matter of this disclosure. In its most general form, it comprises an openable containment structure, the inside of which forms a heating chamber in which, in use, the food product to be heated can be inserted, and where at least a first heating element extending at least mainly in a first plane of extension, and at least a second heating element extending at least mainly in a second plane of extension are mounted. Said heating elements may be switched between a first configuration in which they are facing each other with the first plane of extension parallel to the second plane of extension, and a second configuration in which they are further away from each other than in the first configuration. The first heating element comprises a first plurality of electrically conductive raised elements protruding relative to the first plane of extension towards the second heating element, whilst the second heating element comprises a second plurality of electrically conductive raised elements protruding relative to the second plane of extension towards the first heating element.

To prevent the electromagnetic field from spreading into the surrounding environment, the containment structure may comprise or constitute a screen around the heating chamber, at least for electromagnetic fields with a frequency of between 1 MHz and 300 MHz.

The apparatus also comprises generating means for generating in the heating chamber the radio frequency electromagnetic field, having a frequency of between 1 MHz and 300 MHz, preferably between 10 MHz and 50 MHz, comprising at least two electrodes, each comprising raised elements of the first plurality and/or of the second plurality. In detail, in some embodiments the electrodes comprise a first electrode comprising the first plurality of raised elements and a second electrode comprising the second plurality of raised elements. In contrast, in other embodiments, the electrodes comprise a first electrode and a second electrode, both comprising raised elements of the first plurality and raised elements of the second plurality. Moreover, in each plurality of raised elements, the raised elements that are part of one electrode are alternated with those that are part of the other electrode (alternated along a line perpendicular to the main line of extension of the raised elements). In general, each electrode may be constituted of a single rigid element, as well as a set of electrically connected rigid or flexible elements that in use can reasonably be considered electrically equipotential.

Preferably, in some embodiments the first plurality and the second plurality of raised elements comprise the same number of raised elements, and at least in the first configuration each raised element of the first plurality is directly facing a raised element of the second plurality. In this case, if the two electrodes each comprise raised elements of both of the pluralities, in some embodiments the raised elements of the first plurality that are part of the first electrode are directly facing raised elements of the second plurality that are part of the second electrode, whilst in other embodiments in contrast the raised elements of the first plurality that are part of the first electrode are directly facing raised elements of the second plurality that are also part of the first electrode.

There are also embodiments in which all of the raised elements are the same as each other, and embodiments in which the raised elements are different to each other but the same in groups (for example, all of the raised elements of the first plurality are the same as each other and those of the second plurality are the same as each other).

Preferably, in some embodiments raised elements 9 are constituted each by a bar that extends parallel to respective ones of the first and second planes of extension, while in other embodiments raised elements 9 are integrally provided in one or more plate-shaped conductive elements extending mainly parallel to respective ones of the first and second planes of extension.

Depending on the embodiments, at least one of either the first heating element or the second heating element may delimit the heating chamber, and the raised elements of the first plurality and/or the raised elements of the second plurality may be positioned at a surface of the respective heating element facing towards the heating chamber. This is the case in particular when contact is also required between the raised elements and the food product.

As already indicated relative to the method, even in some example embodiments of the apparatus, the raised elements of the first plurality and/or the raised elements of the second plurality may have a cross-section relative to their main line of extension that has a maximum size less than or equal to 6 mm.

To achieve or accentuate food product squeezing between the first heating element and the second heating element, in some embodiments there may be at least one thrust element positioned between the containment structure and one of either the first heating element or the second heating element, for pushing it towards the other heating element or at least for opposing its movement away from the other heating element, at least when the two are in the first configuration.

Furthermore, in some embodiments the apparatus may also comprise at least one auxiliary heating device, positioned at the heating chamber, for in use heating the outer surface of the food product.

In some preferred embodiments, the apparatus also comprises heating means associated with the first heating element and with the second heating element for heating at least the respective parts of them that are intended to make contact with the food product, to a temperature lower than that to which the outer part of the food product must be heated, but higher than the ambient temperature, so as to limit the amount of heat that the raised elements may take away from the surface of the food product during the heating step. Advantageously, the raised elements are heated to a temperature which is not more than 50° C. lower than that to which the outer part of the food product must be heated. That is to say, at least in most applications, between 90° C. and 140° C.

Said heating means may have any form or structure suitable for the purpose. However, according to the preferred embodiments, they may be:
induction heating means electrically coupled to the first plurality and/or to the second plurality of raised elements, with the raised elements respectively of the first plurality and/or of the second plurality being made of ferromagnetic material; or
heating means using resistors thermally coupled to the first plurality and/or to the second plurality of raised elements.

Alternatively, in other preferred embodiments, the raised elements of the first plurality and/or of the second plurality are constituted of tubular elements and the heating means comprise a hydraulic circuit connected to said tubular raised elements and designed to make a hot fluid circulate in them.

### BRIEF DESCRIPTION OF THE DRAWINGS

Having described the subject matter of this disclosure in general terms above, further features and methods of use will become apparent in the following detailed description of some example embodiments, provided by way of example and without limiting the scope of the disclosure. Reference will be made to the appended figures, which are schematic drawings not necessarily to scale, in which:

FIG. 1 is a schematic view of a first embodiment of an apparatus according to this disclosure in an open configuration;

FIG. 2 shows the apparatus of FIG. 1 in a closed configuration;

FIGS. 3 and 4 show two possible variants of the apparatus of FIG. 1;

FIG. 5 is an axonometric view of a detail of an apparatus made according to this disclosure like that of FIG. 3;

FIG. 6 shows a variant of a detail of the apparatus of FIGS. 1 and 2; and

FIGS. 7 and 8 shows two alternative embodiments of a heating system usable for heating a part of an apparatus made according to this disclosure.

### DETAILED DESCRIPTION OF EXAMPLE EMBODIMENTS

The following description covers first the apparatus, which with reference to the above-mentioned figures is labelled 1 in its entirety, and then the method. Again below, as previously, when for simplicity reference is made only to a sandwich, it shall be understood that in general this also refers to the similar food products indicated above.

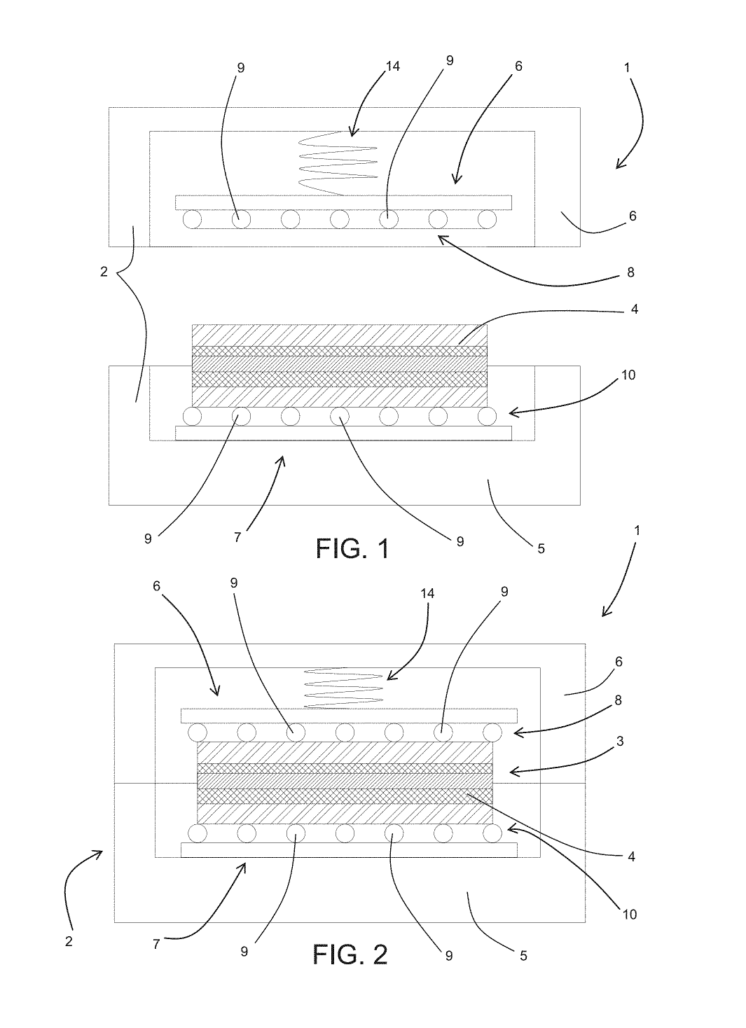

As is schematically illustrated in FIGS. 1 and 2, the apparatus 1 comprises first an openable containment structure 2, the inside of which forms a heating chamber 3 in which in use the food product 4 to be heated can be inserted. When the apparatus 1 is open, the user can insert the sandwich 4 to be heated in the heating chamber 3, whilst when the apparatus 1 is closed, access to the heating chamber 3 is prevented.

In the preferred embodiments, the apparatus 1 is intended to house the sandwich 4 positioned horizontally and for that purpose the containment structure 2 comprises a lower base 5 which forms a supporting surface for the sandwich 4, and an upper cover 6 which can be moved relative to the lower base 5 between a first position in which the apparatus 1 is closed (FIG. 2) and a second position (FIG. 1) in which the apparatus 1 is open. Advantageously, the passage between the first position and the second position, and vice versa, may be obtained by rotating the upper cover 6 about an axis of rotation, even if more complex movements are also possible (for example by means of movements similar to those of a four-raised element linkage).

At the heating chamber 3, the apparatus 1 comprises at least a first heating element 6 and a second heating element 7.

The first heating element 6 extends at least mainly in a first plane of extension, and the second heating element 7 extends at least mainly in a second plane of extension. In the context of this disclosure, the expression extends at least mainly in a plane shall be understood to mean that an object has two orthogonal dimensions that prevail over the third and that define the plane of extension.

The first heating element 6 and the second heating element 7 are switchable between a first configuration, in which they are facing each other, and a second configuration in which they are further away from each other than in the first configuration. Moreover, advantageously, at least in the first configuration the first plane of extension is substantially parallel to the second plane of extension. In use, during heating, the sandwich 4 is positioned between the first heating element 6 and the second heating element 7, which therefore delimit the heating chamber 3 on two opposite main sides.

In the preferred embodiments, the switching of the first heating element 6 and the second heating element 7 from the first configuration to the second configuration and vice versa occurs respectively after opening and closing of the containment structure 2. In the embodiments illustrated that is achieved by mounting the first heating element 6 and the second heating element 7, one on the lower base 5, and the other on the upper cover 6.

According to this invention, the first heating element 6 comprises a first plurality 8 of electrically conductive raised elements 9 having a main line of extension parallel to the first plane of extension, and which protrude relative to the first plane of extension towards the second heating element. Similarly, the second heating element 7 comprises a second plurality 10 of electrically conductive raised elements 9 having a main line of extension parallel to the second plane of extension and which protrude relative to the second plane of extension towards the first heating element. Although in the preferred embodiments all of the raised elements 9 extend in a straight line, it is also possible that they may extend differently, curved, in a zig-zag, etc., but in any case, preferably in such a way as to allow them to lie in the related plane of extension.

In the preferred embodiments which enclosed figures refer to, raised elements 9 are constituted each by a bar that extends parallel to respective ones of the first and second planes of extension, but in other embodiments raised elements 9 can also be integrally provided in one or more plate-shaped conductive elements extending mainly parallel to the respective ones of the first and second planes of extension. In this case, advantageously, all raised elements 9 integrally provided in one plate-shaped element, as well as the plate-shape element, will be electrically equipotential.

The containment structure 2 in turn comprises or itself constitutes (if suitably made of metal material) a screen that surrounds the heating chamber 3, in such a way as to screen at least electromagnetic fields with a frequency of between 1 MHz and 300 MHz. That is to say, the electromagnetic fields used in the heating chamber 3 for the radio frequency heating.

For that purpose, the apparatus 1 also comprises generating means for generating in the heating chamber 3 the radio frequency electromagnetic field with a frequency of between 1 MHz and 300 MHz, which in turn comprise at least two electrodes 11, 12. In accordance with this disclosure, said at least two electrodes 11, 12 are each comprising at least raised elements 9 of the first plurality 8 and/or of the second plurality 10. In particular, in the preferred embodiments the at least two electrodes 11, 12 comprise a first electrode 11 and a second electrode 12 which are intended to be used, one as a high voltage electrode 11, 12 and one as an earth electrode 11, 12. It is also possible that the generating means may comprise an electric or electronic circuit able to invert the operation of the two electrodes 11, 12 either during a single heating, or only before starting a specific heating.

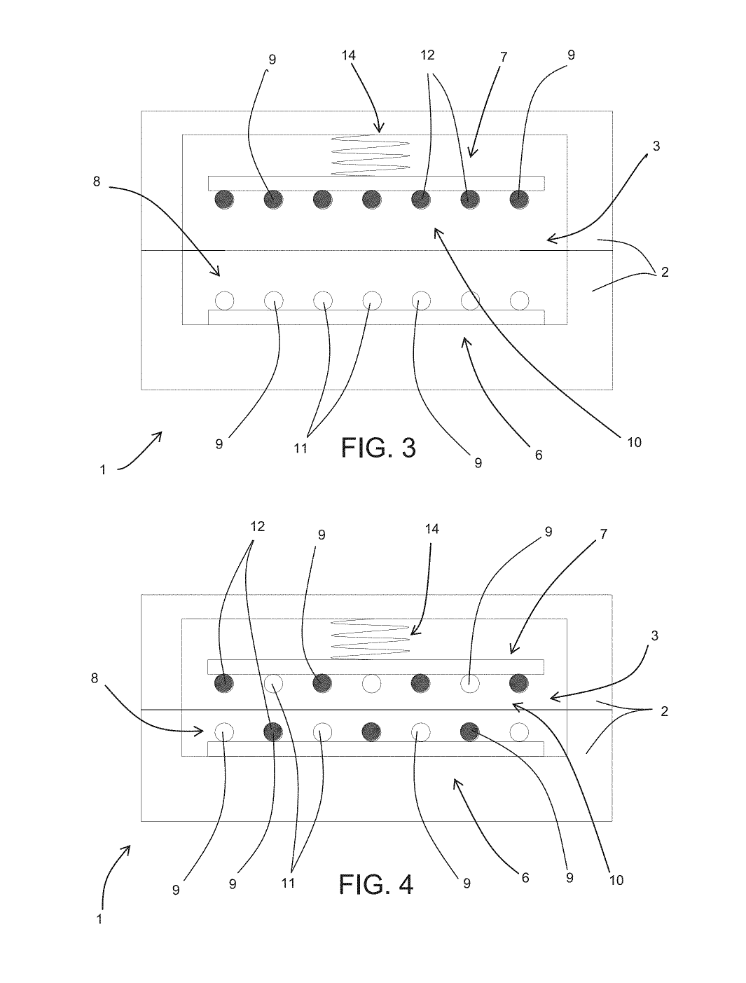

According to a first embodiment illustrated in FIG. 3, the first electrode 11 is constituted at least of the first plurality 8 of raised elements 9, whilst the second electrode 12 is constituted at least of the second plurality 10 of raised elements 9. In the context of this disclosure, with the definition that an electrode 11, 12 is constituted at least of a predetermined group of raised elements 9, preferably it shall be understood that said electrode 11, 12 as well as said raised elements 9 may comprise electrically conductive elements that connect the various raised elements 9 together to guarantee their substantial electrical equipotentiality (as illustrated for example in FIG. 10, where the ends of the raised elements 9 facing the same side are all connected to a single collector 13 or, as in the case of raised elements 9 integrally provided in conductive plate-shaped elements).

When all of the raised elements 9 of a plurality 8, 10 are part of the same electrode 11, 12, what is obtained is a radio frequency heating system in which the electromagnetic field in the space located between the first heating element 6 and the second heating element 7, has a mean direction of propagation substantially perpendicular to the first plane and to the second plane (the heating is carried out when the two planes are parallel to each other). The expression mean direction of propagation refers to the direction of the vector indicating the vectorial mean of the directions of propagation in the relevant space.

According to a second embodiment, both the first electrode 11 and the second electrode 12 are each constituted both of raised elements 9 of the first plurality 8, and of raised elements 9 of the second plurality 10. In this case preferably, both in the first plurality 8 of raised elements 9 and in the second plurality 10 of raised elements 9, the raised elements 9 that constitute the first electrode 11 are alternated with those that constitute the second electrode 12 (alternated moving along a line perpendicular to the main line of extension of the self-same raised elements 9).

If the raised elements 9 that constitute the first electrode 11 are alternated with those that constitute the second electrode 12, it is possible either that they are positioned overall in such a way as to create in the space between the first heating element 6 and the second heating element 7 two “stray-field” type fields which, in use, mainly affect only the surface portions of the food product 4 near to the first heating element 6 and to the second heating element 7, or that they are positioned overall in such a way as to create in said space an overall electromagnetic field that corresponds to the superposing of a field having a mean direction of propagation substantially parallel to the first plane of extension and of two “stray-field” type fields. In both cases, it is preferable that the first plurality 8 and the second plurality 10 of raised elements 9 each comprise the same number of raised elements 9, and that, at least in the first configuration, each raised element 9 of the first plurality 8 is directly facing a raised element 9 of the second plurality 10. However, in the former case, the raised elements 9 directly facing each other belong to the same electrode 11, 12 (arrangement not shown in the accompanying figures), whilst in the latter case the raised elements 9 directly facing each other belong to different electrodes 11, 12 (FIG. 4), so that the raised elements 9 of the first plurality 8 that constitute the first electrode 11 are directly facing raised elements 9 of the second plurality 10 that constitute the second electrode 12, and the raised elements 9 that constitute the first electrode 11 of the second plurality 10 are directly facing raised elements 9 of the first plurality 8 that constitute the second electrode 12. Moreover, preferably, the distances between each raised element 9 that constitutes the first electrode 11 (for example, a raised element 9 represented by a white circle in FIG. 4) and the raised elements 9 that constitute the second electrode 12 which are respectively alongside and facing it (that is to say, respectively belonging to same plurality 8, 10 or to the other plurality 8, 10—in FIG. 4 the raised elements 9 shown by a black circle nearest to it) are selected in such a way that in the absence of the food product 4 the maximum intensity of the electromagnetic field generated between the first raised element 9 in question and respectively the second raised element 9 alongside it and the one facing it, have a mutual ratio of between 0.5 and 2. In some embodiments, in particular, each raised element 9 of one plurality 8, 10 may have the same distance both from the raised element 9 alongside it of the same plurality 8, 10, and from the raised element 9 facing it of the other plurality 8, 10.

Preferably, the first heating element 6 and/or the second heating element 7 delimit the heating chamber 3 and in some embodiments respectively the raised elements 9 of the first plurality 8 and/or the raised elements 9 of the second plurality 10 are positioned at a surface respectively of the first heating element 6 and/or of the second heating element 7 facing towards the heating chamber 3. In the accompanying figures that is achieved thanks to the fact that said surface is defined by the same raised elements 9. In other embodiments, it is also possible that the raised elements 9 are completely or partly embedded in other materials (which are not electrically conductive) and/or that there is at least one different material present between them and the heating chamber 3.

Preferably, the raised elements 9 of the first plurality 8 and/or the raised elements 9 of the second plurality 10 have, transversally to their main line of extension, a cross-section that has a maximum size less than or equal to 6 mm. Moreover, advantageously, the raised elements 9 have a circular, semicircular, elliptical or semielliptical cross-section.

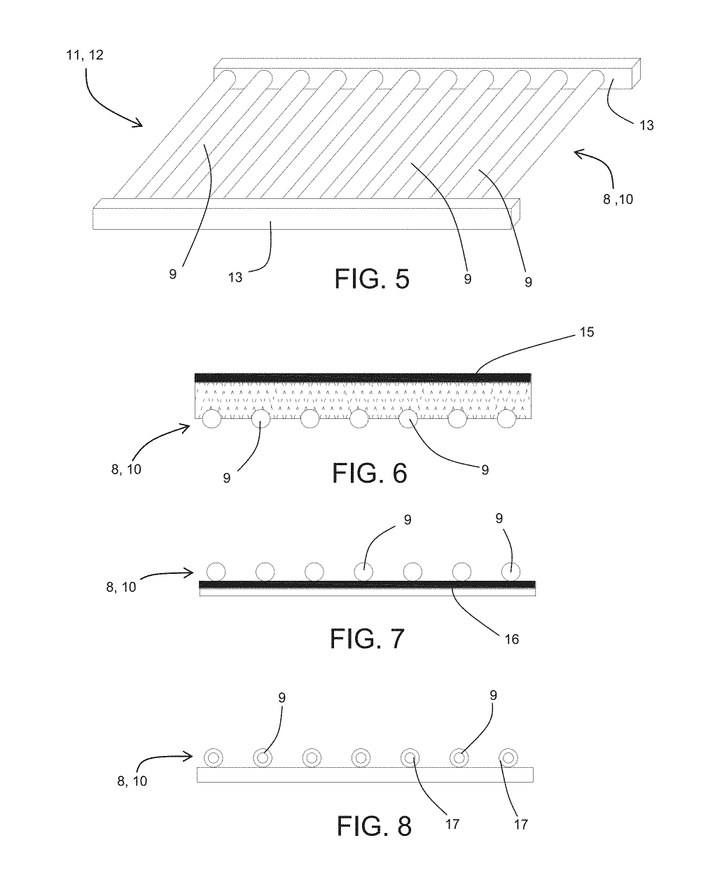

In the preferred embodiments, the raised elements 9 of the first plurality 8 and/or the raised elements 9 of the second plurality 10 are all parallel to each other (as in FIG. 5) or positioned across one another in a grid. However, other arrangements are possible.

In some embodiments, to guarantee good compression of the sandwich 4 between the first heating element 6 and the second heating element 7, as illustrated in FIGS. 1 and 2 the apparatus 1 may also comprise at least one thrust element 14 positioned between the containment structure 2 and one of either the first heating element 6 or the second heating element 7 for pushing said heating element 6, 7 towards the other heating element 6, 7 or for opposing its movement away from the other heating element 6, 7, at least when the first heating element 6 and the second heating element 7 are in the first configuration. As is schematically illustrated in FIGS. 1 and 2, in a preferred embodiment the thrust element 14 is constituted of one or more springs that oppose the away movement. At the same time, to ensure that the away movement and the compression are always present, the first heating element 6 and the second heating element 7 are mounted in such a way that in the first configuration the distance between them is less than the thickness of any sandwich 4 intended to be inserted in the heating chamber 3. However, in other embodiments, the “empty” distance between the first heating element 6 and the second heating element 7 may be adjustable so as to adapt the apparatus 1 to different uses, or the force applied by the thrust element 14 may be adjustable (for example, it is possible that if springs are used they are preloadable).

Some embodiments also involve the apparatus 1 also comprising at least one auxiliary heating device 15 positioned at or near to the heating chamber 3 for the purpose of, in use, heating the outer surface of the food product 4. Advantageously, that auxiliary heating device 15 may be of the type using infrared, resistors or hot air. In the case shown in FIG. 6, it is constituted of an infrared heating system positioned immediately behind the raised elements 9 of one plurality 8, 10. Moreover, with that layout, on one hand it supplies heat to the food product 4 through the free spaces present between two adjacent raised elements 9, and on the other hand it also heats the raised elements 9 by acting as heating means 16 of the type described in the following paragraph.

As illustrated in particular in FIGS. 7 and 8 (and partly, as seen, in FIG. 6), which illustrate by way of example a generic plurality 8, 10 of raised elements 9 (which may therefore be either the first plurality 8 or the second plurality 10), in some embodiments the apparatus 1 also comprises heating means 16 that can be associated with at least one of either the first heating element 6 or the second heating element 7, for heating at least the parts of them intended to make contact with the food product 4. Advantageously, said parts are heated as described above, so as to prevent the heating element 6, 7 from being able to remove too much heat from the surface of the sandwich 4, considering that surface browning of bread normally requires temperatures in the range between 140° C. and 165° C. In the preferred embodiments, illustrated in the accompanying figures, the heated parts of the first heating element 6 and/or of the second heating element 7 are the related raised elements 9.

According to an embodiment illustrated in FIG. 7, the heating means 16 may be induction heating means 16 electrically coupled to the first plurality 8 and/or to the second plurality 10 of raised elements 9. Moreover, in that case, the raised elements 9, respectively of the first plurality 8 and/or of the second plurality 10, will be made of ferromagnetic material.

According to another embodiment, not illustrated, the heating means 16 are resistor-type heating means 16 thermally coupled to the first plurality 8 and/or to the second plurality 10 of raised elements 9.

According to another embodiment, illustrated in FIG. 8, in contrast, on one hand the raised elements 9, respectively of the first plurality 8 and/or of the second plurality 10, may be constituted of tubular elements 17 and, on the other hand the heating means 16 may comprise a hydraulic circuit connected to the tubular raised elements 9, respectively of the first plurality 8 and/or of the second plurality 10, for making a hot fluid, advantageously hot water or pressurized steam circulate in the raised elements 9.

Operation of the apparatus 1 constitutes a particular case of implementing the method according to this disclosure, which will now be described in detail.

In its most general embodiment, that method for heating the food product 4 before it is consumed comprises the operating steps of:
enclosing the food product 4 between at least a first heating element 6 comprising a first plurality 8 of electrically conductive raised elements 9 protruding towards a second heating element 7, and a second heating element 7 comprising a second plurality 10 of electrically conductive raised elements 9 protruding towards the first heating element 6; and
using the raised elements 9 of the first plurality 8 and of the second plurality 10 as electrodes 11, 12, radio frequency heating the food product 4 using an electromagnetic field having a frequency of between 1 MHz and 300 MHz.

In more detail, preferably the step of enclosing the food product 4 between the first heating element 6 and the second heating element 7 is implemented using a first heating element 6 that extends in a first plane of extension, and a second heating element 7 facing the first heating element 6 and extending in a second plane of extension that is parallel to the first plane of extension. The raised elements 9 of the first plurality 8 are parallel to the first plane of extension, whilst the raised elements 9 of the second plurality 10 are parallel to the second plane of extension. Advantageously, as said, raised elements 9 can be constituted by bars or be integrally provided in one of the plate-shaped conductive elements.

In the preferred embodiments, at least during the radio frequency heating step, the first heating element 6 and the second heating element 7 remain in contact with an outer surface of the food product 4. Moreover, preferably at least the raised elements 9 of the first plurality 8 and of the second plurality 10 remain in contact with the outer surface of the food product 4.

Even more preferably, to guarantee optimum contact between the first heating element 6 and/or the second heating element 7 and the food product 4, during the radio frequency heating step the food product 4 is also squeezed between the first heating element 6 and the second heating element 7. In this way, it is possible to minimize the risk of unwanted local burning on the surface of the sandwich 4, which may in contrast occur if there is non-uniform contact between the raised elements 9 and the sandwich 4.

As already indicated, advantageously, use will be made, in the first plurality 8 and/or in the second plurality 10, of raised elements 9 which have, relative to their own main line of extension, a cross-section with a maximum size that is less than or equal to 6 mm, the cross-section preferably being circular or elliptical.

Regarding the direction of propagation of the electromagnetic field in the space between the first heating element 6 and the second heating element 7, various solutions are possible. According to a first embodiment, it is generated with a mean direction of propagation transverse to the first plane of extension. According to a second embodiment, its direction of propagation is parallel to the first plane of extension. And according to a third embodiment, its direction of propagation comprises a first component parallel to the first plane of extension and a second component transverse to the first plane of extension. In the latter case, preferably, in the absence of the food product 4, the first component and the second component respectively have a first intensity and a second intensity which have a mutual ratio of between 0.5 and 2.

According to a particularly preferred embodiment, to guarantee optimum browning of the surface of the food product 4 together with a marking of the surface at the raised elements 9 similar to that obtainable using normal resistive plates, during the radio frequency heating step or immediately before the radio frequency heating step, there is also a step of heating at least the first plurality 8 of raised elements 9 and the second plurality 10 of raised elements 9, so as to prevent them from being able to remove too much heat from the food product 4 according to the methods already described. In the various embodiments this may be achieved for example by heating the raised elements 9 using induction, resistors and/or using a hot fluid that is made to circulate in them.

In some embodiments, during the radio frequency heating step, there may also be an additional step of heating the surface of the food product 4 by means of heating using infrared, resistors or hot air.

Finally, before the food product 4 is inserted between the first heating element 6 and the second heating element 7, there may be a step of applying an edible fat on the outer surface of the food product 4.

Finally, it should be noticed that what is described relative respectively to the apparatus 1 and to the method, shall be considered valid, if applicable, also respectively for the method and for the apparatus 1.

Some final considerations.

Regarding the choice both of the power and of the frequency of the radio frequency heating, it is possible either to use constant values for the entire heating, or to vary them during the heating. Furthermore, it is possible to control either the power generated or that actually transmitted to the food product 4 using a feedback system. The choice of the method of implementation may be made by persons who are experts in the field, who, also based on the devices to be used for generating the electromagnetic field (in particular generator and matching box) will also be able to use simple tests to find the solution that is best in their opinion.

For example, it should be noticed that preliminary tests carried out by the Applicant showed how it is possible to satisfactorily heat in less than one minute, sandwiches filled with cheese and ham by operating either at 13.56 MHz or at 27.12 MHz and at powers, constant or variable, of less than 500/600 W. In this way, in particular, it was possible to heat the sandwiches in a very uniform way, that is to say, with temperatures in the various inner and outer points all between 50° C. and 60° C. (measured manually with a thermal probe a few seconds after the end of the heating, that is to say, within a time comparable to that which, in use, elapses between the end of heating and the handover of the sandwich 4 to the consumer).

What is described above brings important advantages.

In fact, it was possible to develop an apparatus 1 and a method for heating a food product 4 constituted of a sandwich 4 or the like, before its consumption, that allow both reduced heating times and a good temperature uniformity inside the food product 4.

Furthermore, with heating times comparable to those of the prior art combined system which simultaneously uses microwaves, infrared and resistors, the apparatus 1 and the method described above allow more uniform heat distributions between the various products present in the food product 4.

Finally, it should be noticed that what was developed is relatively easy to produce and that even the cost linked to implementing it is not very high.

It may all be modified and adapted in several ways without thereby departing from the scope of the inventive concept.

All details may be substituted with other technically equivalent elements and the materials used, as well as the shapes and dimensions of the various components, may vary according to requirements.

1. An apparatus for heating a food product constituted of a sandwich or the like, before it is consumed, comprising:
an openable containment structure, the inside of which forms a heating chamber in which in use the food product to be heated can be inserted;
at least a first heating element extending at least mainly in a first plane of extension, mounted in the containment structure at the heating chamber; and
at least a second heating element extending at least mainly in a second plane of extension, mounted in the containment structure at the heating chamber;
the first heating element and the second heating element being switchable between a first configuration, in which they are facing each other, with the first plane of extension parallel to the second plane of extension, and a second configuration in which they are further away from each other than in the first configuration;
wherein:
the first heating element comprises a first plurality of electrically conductive raised elements protruding relative to the first plane of extension towards the second heating element;
the second heating element comprises a second plurality of electrically conductive raised elements protruding relative to the second plane of extension towards the first heating element;
the containment structure comprises or constitutes a screen for electromagnetic fields with a frequency of between 1 MHz and 300 MHz which surrounds the heating chamber; and
the apparatus also comprises generating means for generating in the heating chamber a radio frequency electromagnetic field with a frequency of between 1 MHz and 300 MHz, which comprise at least two electrodes, each comprising raised elements of the first plurality and/or of the second plurality.

2. The apparatus according to claim 1, wherein said at least two electrodes comprise a first electrode comprising at least the first plurality of raised elements and a second electrode comprising at least of the second plurality of raised elements.

3. The apparatus according to claim 1, wherein said at least two electrodes comprise a first electrode and a second electrode, both comprising both raised elements of the first plurality and of raised elements of the second plurality, in each plurality of raised elements, the raised elements that are part of the first electrode alternating with those that are part of the second electrode, along a line perpendicular to their main line of extension.

4. The apparatus according to claim 3, wherein the first plurality and the second plurality of raised elements each comprise the same number of raised elements, wherein, at least in the first configuration, each raised element of the first plurality is directly facing a raised element of the second plurality, and wherein the raised elements of the first plurality that are part of the first electrode are directly facing raised elements of the second plurality that are part of the second electrode.

5. The apparatus according to claim 1, wherein the first plurality and the second plurality of raised elements each comprise the same number of raised elements, and wherein, at least in the first configuration, each raised element of the first plurality is directly facing a raised element of the second plurality.

6. The apparatus according to claim 1, wherein respectively the first heating element and/or the second heating element delimit the heating chamber and wherein respectively the raised elements of the first plurality and/or the raised elements of the second plurality are positioned at a surface respectively of the first heating element and/or of the second heating element facing towards the heating chamber.

7. The apparatus according to claim 1, wherein the raised elements of the first plurality and/or the raised elements of the second plurality have, transversally to their main line of extension, a cross-section that has a maximum size less than or equal to 6 mm.

8. The apparatus according to claim 1, wherein the raised elements of the first plurality and/or the raised elements of the second plurality are all parallel to each other or arranged in a grid.

9. The apparatus according to claim 1, wherein raised elements of the first plurality and/or of the second plurality are constituted each by a bar.

10. The apparatus according to claim 1, wherein raised elements of the first plurality and/or of the second plurality are integrally provided in one or more plate-shaped conductive elements.

11. The apparatus according to claim 1, also comprising at least one thrust element positioned between the containment structure and the first heating element for pushing the first heating element towards the second heating element or for opposing a movement of the first heating element away from the second heating element, at least when the first heating element and the second heating element are in the first configuration.

12. The apparatus according to claim 1, also comprising at least one auxiliary heating device positioned at or near to the heating chamber for, in use, heating an outer surface of the food product.

13. The apparatus according to claim 1, also comprising heating means associated with the first heating element and/or the second heating element for heating at least their respective parts intended to make contact with the food product, to a temperature of between 90° C. and 140° C.

14. The apparatus according to claim 13, wherein the heating means are induction heating means electrically coupled to the first plurality and/or to the second plurality of raised elements, and wherein the raised elements, respectively of the first plurality and/or of the second plurality, are made of ferromagnetic material.

15. The apparatus according to claim 13, wherein the heating means are resistor-type heating means thermally coupled to the first plurality and/or to the second plurality of raised elements.

16. The apparatus according to claim 13, wherein the raised elements respectively of the first plurality and/or of the second plurality are constituted of tubular elements and wherein the heating means comprise a hydraulic circuit connected to the raised elements respectively of the first plurality and/or of the second plurality for making a hot fluid circulate in the heating means.

17. A method for heating a food product constituted of a sandwich or the like, before it is consumed, comprising the operating steps of:
enclosing the food product between at least a first heating element extending in a first plane of extension and a second heating element facing the first heating element and extending in a second plane of extension that is parallel to the first plane of extension, the first heating element comprising a first plurality of electrically conductive raised elements protruding relative to the first plane of extension towards the second heating element and the second heating element comprising a second plurality of electrically conductive raised elements protruding relative to the second plane of extension towards the first heating element; and
using the raised elements of the first plurality and of the second plurality as electrodes radio frequency heating the food product using an electromagnetic field having a frequency of between 1 MHz and 300 MHz.

18. The method according to claim 17, wherein at least during the radio frequency heating step, the first heating element and the second heating element remain in contact with an outer surface of the food product.

19. The method according to claim 18, wherein when the first heating element and the second heating element are in contact with an outer surface of the food product, the raised elements of the first plurality and of the second plurality also remain in contact with the surface of the food product.

20. The method according to claim 17, wherein during the radio frequency heating step, the food product is also squeezed between the first heating element and the second heating element.
